(19) United States
(12) Patent Application Publication
(10) Pub. No.: US 2024/0375077 A1
(43) Pub. Date: Nov. 14, 2024

(54) PROCESS INTENSIVE REACTORS WITH REDUCED THERMAL STRESS

(71) Applicant: Battelle Memorial Institute, Richland, WA (US)

(72) Inventors: Ward E. TeGrotenhuis, Kennewick, WA (US); Paul H. Humble, Kennewick, WA (US); Timothy G. Veldman, Kennewick, WA (US); Richard F. Zheng, Lake Oswego, OR (US); Robert S. Wegeng, Richland, WA (US); Dennis Walters, Richland, WA (US); Daryl Brown, Richland, WA (US)

(21) Appl. No.: 18/692,667

(22) PCT Filed: Sep. 16, 2022
(86) PCT No.: PCT/US22/43900

§ 371 Date: Mar. 15, 2024

Related U.S. Application Data
(60) Provisional application No. 63/245,182, filed on Sep. 16, 2021.

(51) Int. Cl. B01J 19/24; B01J 19/12

(52) U.S. Cl. CPC B01J 19/248; B01J 19/122; B01J 2219/0892; B01J 2219/1941

(57) ABSTRACT

Reactors subject to large variations in temperatures are subject to thermal stresses that can lead to failure or process disruption. In the present invention, reactors designs are provided that protect the reactor from thermal stress. Thermal stress can be reduced by providing expansion joints, or varying wall thickness or stiffness to adjust for thermal expansion.

### RELATED APPLICATIONS

This application claims the priority benefit of U.S. Provisional Patent Application 63/245,182, filed 16 Sep. 2021.

### BACKGROUND

TeGrotenhuis et al., Zheng et al. and Wegeng et al. have designed reactors for utilizing solar radiation from solar concentrators. See U.S. Pat. Nos. 10,981,141, 11,358,111 and 9,950,305 which are incorporated herein by reference. Typically, these are disk-shaped reactors in which an exterior surface is paired with a solar concentrator. This work however, does not describe means of reducing stress from thermal expansion.

Integrated heat transfer reactors with small channels have long been used for thermal chemical reactions. Designs for these reactors have dealt with the problem of thermal expansion. For example, in U.S. Pat. No. 7,931,875, Tonkovich et al. address the problem of thermal expansion by leaving the hottest end of the reactor free to expand. U.S. Pat. Nos. 9,134,079 and 9,475,026 describe various manifold designs and flow control through a plurality of parallel channels. Despite these and other work, there remains a need to reduce thermal stresses and control flow in disk-shaped reactors that take in energy from the environment (for example from a solar concentrator or induction heating or other energy source) through or within an exterior wall of the reactor.

### SUMMARY OF THE INVENTION

In a first aspect, the invention provides a disk-shaped apparatus, comprising:
a central axis; a disk comprising a first set of channels radiating from the central axis toward the perimeter of the disk; wherein the first set of channels comprise a plurality of channels wherein each of the channels in the plurality of channels comprise at least one inlet disposed around the central axis; a fluid inlet disposed parallel to and along the central axis;
a plurality of connections between the fluid inlet and the at least one inlet of each of the channels; wherein each channel has a first cross-sectional area that is perpendicular to channel length and each single inlet or plurality of inlets has a second cross-sectional area; wherein the disk comprises a circular top wall over a major surface of the disk and a cylindrical side wall around the perimeter of the disk; and further comprising one or any combination of the following features: wherein each channel in the plurality of channels comprises an expansion joint along the channel length; wherein the side wall is thicker or stiffer than the top wall; wherein each of the channels in the plurality of channels have a width that is perpendicular to length and thickness and wherein the width narrows toward the perimeter of the disk so that the wall thickness increases toward the perimeter; or wherein the second cross-sectional area is at least 20%, or 50%, or 70% less than the first cross-sectional area.

In any of its aspects, the invention can be further characterized by one or any combination of the following: wherein each wall of the reactor is made of a single material; and wherein the single material is a superalloy; wherein each channel in the plurality of channels comprises an expansion joint along the channel length; wherein the expansion joint is selected from the group consisting of: a tongue-in-groove joint, an angled gap, a thinned wall, a thinned wall to a gap, bellows, or a gap with an overlapping flange; wherein the expansion joint comprises an angled gap wherein the angled gap is angled in the direction of flow, angled against flow, or angled with a V; wherein the expansion joint is a tongue-in-groove joint; wherein the expansion joint comprises a thinned wall wherein the wall thins to a thickness that is at least 40% thinner (or at least 60% thinner) than the average thickness of the wall; wherein the average is over the length of the channel not including the thinned section; wherein the side wall is thicker or stiffer than the top wall; wherein the side wall is made of a material that is stiffer than the top wall; wherein each of the channels in the plurality of channels have a width that is perpendicular to length and thickness and wherein the width narrows toward the perimeter of the disk so that the wall thickness increases toward the perimeter; wherein the central fluid inlet is perpendicular to each of the channels in the plurality of channels; wherein the reactor comprises a first disk-shaped layer of reaction channels comprising a solid catalyst and a second disk-shaped layer comprising heat recuperation channels wherein reaction products made in the first layer can pass into return channels in the second layer that return toward the central axis; wherein the second cross-sectional area is at least 20%, or 50%, or 70% less than the first cross-sectional area; wherein the expansion joint comprises a bellows; and comprising a central aperture through the entire thickness of the disk-shaped apparatus.

The invention also includes methods of conducting a thermal chemical reaction, comprising passing a reactant into the apparatus, and further comprising a step of adding heat into the reaction channels through an exterior wall of the reaction channels that is opposite the heat recuperation channels.

In a further aspect, the invention provides a method of conducting a thermal chemical reaction, comprising: providing a disk shaped apparatus, comprising: a central axis; a disk comprising a first set of channels radiating from the central axis toward the perimeter of the disk; wherein the first set of channels comprise a plurality of channels wherein each of the channels in the plurality of channels comprise at least one inlet disposed around the central axis;

a fluid inlet disposed parallel to and along the central axis; a plurality of connections between the fluid inlet and the at least one inlet of each of the channels; wherein the disk comprises a circular top wall over a major surface of the disk and a cylindrical side wall around the perimeter of the disk; applying heat through the major surface of the disk (e.g., the Exterior Horizontal plate of FIG. 8c) wherein the heat flux is higher near the center of the reactor and decreases toward the perimeter of the reactor.

In any of its aspects, the invention can be further characterized by one or any combination of the following: wherein the thermal chemical reaction is an endothermic reaction; wherein the thermal chemical reaction comprises reforming of hydrocarbons (including methane) or a reverse-water-gas shift reaction; wherein heat flux over the 50% of area of the major surface nearest the center of the disk is at least 10% greater or at least 20% greater than the 50% of area of the major surface furthest from the center of the disk.

In another aspect, the invention provides a disk shaped apparatus, comprising:
a central axis; a disk comprising a first set of channels radiating from the central axis toward the perimeter of the disk; wherein the first set of channels comprise a plurality of channels wherein each of the channels in the plurality of channels comprise at least one inlet disposed around the central axis; a fluid inlet disposed parallel to and along the central axis; a plurality of connections between the fluid inlet and the at least one inlet of each of the channels; wherein the disk comprises a circular top wall over a major surface of the disk and a cylindrical side wall around the perimeter of the disk; wherein the first set of channels define a first layer; and further comprising a second layer adjacent to the first layer; wherein the second layer comprises a second set of channels extending from the perimeter of the disk to the central axis, and wherein the first set of channels connect to the second set of channels at the perimeter so that flow from the first set of channels passes into the second set of channels; and wherein a catalyst is present in the first set of channels and wherein the catalyst is present in the second set of channels such that at least 90 mass % of the catalyst in the second set of channels is present in the 50% of channel length closest to the perimeter.

The invention also includes a methods of conducting a thermal chemical reaction in any of the apparatus described herein.

Typically, each channel has a cross-sectional area that is essentially constant over the channel length. Having a reduced cross-section at the inlet (the interface between the central fluid inlet and the plurality of channels) creates a pressure drop that equalizes or tailors flow to the plurality of channels. The channels can have any length, typically at least one meter or at least 2 meters in one direction; height is typically 1 mm to 1 cm but can be more; width is typically 1 mm to 1 cm but can be more.

Typically, each wall of the reactor is made from a single material; typically a superalloy having good strength at high temperature. In the case where the walls are welded onto a sheet, thickness is measured on the piece being welded onto the reactor; in the case where the channels are formed in a single piece of material, the wall thickness is measured from the exterior of the wall (the side facing the environment) to the closest edge of a channel. A “stiffer” wall is a wall exhibiting less deformation as compared to a piece of equal area (in the dimensions perpendicular to thickness) when an equal force is applied at a selected temperature (800° C., unless specified otherwise). In preferred embodiments, thickness and/or stiffness is at least 10%, 20%, or at least 50% greater (in some embodiments up to 100% greater) Typically, the central fluid inlet is perpendicular to each of the channels in the plurality of channels.

In some embodiments, the reactor is a two layer reactor with a first disk-shaped layer of reaction channels comprising a solid catalyst and a second disk-shaped layer comprising heat recuperation channels wherein reaction products made in the first layer can pass into return channels in the second layer that return toward the central axis. The expansion joint is preferably selected from a tongue-in-groove joint, an angled gap (angled in the direction of flow, angled against flow, angled with a V), a thinned wall, a thinned wall to a gap, bellows, or a gap with an overlapping flange.

### BRIEF DESCRIPTION OF THE DRAWINGS

FIG. 1. Two Layer Reactor showing cut away exposing the channels (bottom) and recuperation (top) channels as well as the flow distribution header (center of reactor). This shows the high temperature alloy parts of the reactor, optional foam catalyst inserts are not shown, but could be placed in the lower channels in this figure.

FIG. 2. Stress (Von Mises stress in psi) in two-layer reactor at 6 kW heat input and 85% conversion and 280 psig internal pressure with increased reaction channel wall thickness near reactor perimeter to reduce thermal expansion and pressure induced stress. The maximum stress on the surface of the reactor is about 30 ksi (kilopound per square inch) on the non-heated surface and about 22 ksi on the top (hot) part of the reactor.

FIG. 3. Three-layer reactor showing a cutaway view (left) and full reactor (right). The three-layer reactor has catalyst filled channels adjacent to the top and bottom surfaces of the reactor. These catalyst channels sandwich recuperation channels.

FIG. 4. Header for three-layer reactor.

FIG. 5. Wire-frame rendering of reactor internals at the center of the reactor. The cross-spiral flow of the recuperation channels can be seen in this view as well as the spoke arrangement of the inlet and outlet header.

FIG. 6. Finite element simulation results showing stress in a reactor cross-section near the perimeter of the reactor. This reactor geometry has thicker reaction channel side walls near the device perimeter. The maximum stress in the reaction channel wall reduced to around 206 MPa (30 ksi). Also, the maximum stress has shifted toward the center of the reactor which is lower in temperature and better able to withstand the stress.

FIG. 7. Finite element simulation results showing stress in a reactor cross-section near the perimeter of the reactor. This reactor geometry incorporates a break in the internal walls of the reaction channel. This break acts as an expansion joint and reduces the stress in the internal reactor structure. In his simulation the maximum stress was less than 20.6 MPa (3 ksi).

FIG. 8a schematically illustrates a cutaway sideview of a 3 layer reactor.

FIG. 8b illustrates a configuration with gaps to allow for low stress expansion.

FIG. 8c (top) shows top-down views of four horizontal layers of the reactor and (bottom) the flow channels with gaps in the vertical walls separating channels.

FIG. 9 schematically illustrates types of expansion joints that can be used to reduce thermal stress in reactor walls.

### REACTOR DESIGNS

Designs for flat plate reactors, for steam reforming of hydrocarbons and other endothermic reactions, have been developed with variations that include design improvements that reduce thermal expansion stresses. These designs have built upon previous solar thermochemical methane steam reformers; however, the current reactor designs have been developed for use with electrical inductive heating. Other heat sources that could be utilized include radiant energy (e.g., solar concentrator, lamps, microwaves, etc.) as well as electrical (e.g., induction heating, resistance heating).

These reactor designs are disk shaped and include a two-layer design and three-layer design. The steam reforming reactors operate at high temperatures (700 to 900° C.) and at elevated pressures, for example up to 15-20 bar or higher. At these high temperatures and pressures material strength is a prime concern and the reactors are constructed of metal alloys such as nickel or cobalt superalloys (e.g., Haynes 230 and 282) that are specifically designed for high temperature applications.

At these high operating temperatures creep rupture is a potential failure mechanism, and the reactors need to be designed to minimize the stress in the reactor structure caused by the internal pressure, especially since pressure induced stress is constant at a given pressure during operation. Thermal expansion stresses are also of concern. Unlike pressure induced stress, thermal expansion stresses will relax with holding time at high temperature due to creep. Because of this the thermal expansion stress is not a constant stress when operating but will be present when the device is being heated and at the start of operation. The concern with thermal stress is that it could contribute to cyclic fatigue failure after multiple cycles of operation as the reactor is heated and cooled. The thermal expansion stresses can be larger than the steady state pressure induced stress. It is desirable to maximize the operating lifetime of the reactors, and to do this both pressure and thermal expansion stresses should be minimized. Here we discuss several design features that result in reduced thermal expansion stresses in flat plate reactors, along with other unique features of these flat plate reactors. These features were developed and analyzed with the use of finite element modeling (COMSOL Multiphysics) to model thermal expansion stress, simulate reactor performance and test improvements. The reactor designs are described along with modeling results and feature descriptions.

### Two-Layer Reactor

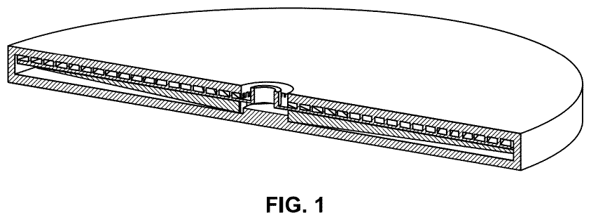

The first reactor concept is a two-layer design (two layers of flow channels) with reaction channels adjacent to an externally applied heat source and recuperation channels adjacent to the unheated surface of the disk. A cut away view of half of this reactor design is shown in FIG. 1. In this two-layer design the reacting gas enters the device near the center of the disk. While many endothermic reactions could be accomplished by this design, for simulations a feed gas consisting of a mixture of methane and steam was assumed to flow into a header that distributes the incoming gas to multiple catalyst filled reaction channels (positioned like spokes of a wheel) where the gas flows through hot catalyst toward the perimeter of the disk. The header is designed to evenly distribute the feed gas to the different reaction channels, even when the heat input into the reactor is not uniformly distributed. This is accomplished using an innovative header design with small inlet channels. An endothermic steam reforming reaction can take place in the catalyst filled reaction channels that converts the steam and methane into hydrogen, carbon monoxide and carbon dioxide. The endothermic steam reforming reaction requires the addition of heat, and the catalyst filled channels are heated by an external heat source applied to and/or within the outside surface (bottom surface in the figure) adjacent to the catalyst channels. Types of heat sources that can be applied include electrical inductive heaters, electrical resistive heaters, microwave heaters, concentrated solar from a dish, trough or other solar concentrator, and other radiant energy sources. At the outside perimeter of the device (disk) the flow changes direction and flows back toward the center of the disk-shaped reactor though recuperation channels that do not contain catalyst. The hot gas in these recuperation channels provides some heat to the reaction, as heat is transferred from the hot product gas to the somewhat cooler reacting gas in the reaction channels. The recuperation channels may be shaped in a spiral or curved configuration to provide a cross spiral in relation to the reaction channels, the reaction channels may be shaped in a spiral or curved configuration in relation to straight recuperation channels, or alternately both sets of channels may be straight or spiral/curved. This cross-spiral or curved configuration helps spread heat between reaction channels, decreasing hot spots and enabling more uniform conversion between the multiple reaction channels. This is especially beneficial when using non-uniform heat sources such as concentrated solar or inductive heating. The recuperation also lowers the temperature of gas exiting the reactor, enabling the high temperature recuperator to operate at a lower temperature, increasing the strength, decreasing the size, and/or increasing the lifetime of the recuperator.

In any of the designs, the reaction channels may have heights that are less than 1 mm but preferably range from 1 to 10 mm or 3 to 6 mm in height (direction perpendicular to flow and parallel to direction of heat input) and the recuperation channels may have heights that are less than 1 mm but or may range from 1 to 10 mm or 1 to 6 mm in height. The walls that separate the adjacent reaction channels or adjacent recuperation channels are preferably 0.3 to 2 mm or 0.5 to 1 mm in thickness. The walls that separate reaction and recuperation channels are preferably 0.4 to 4 mm or 0.5 to 2 mm thick.

In operation this two-layer reactor experiences thermal expansion stress as the heated external wall adjacent to the reaction channel expands (bottom surface in FIG. 1). The opposite unheated surface (top surface) is lower in temperature and does not expand as much as the heater surface. This causes the reactor to dish (warp into a dish-like shape), and this also creates thermal expansion stresses due to the temperature gradients and nonuniform expansion produced in the reactors metal structure.

Heat inputs may vary from less than 1 kW to tens of kW, or even over 100 kW. In a preferred embodiment, the reactor is designed to operate at 6 to 12 kW of heat input resulting in heat fluxes in the range of 9.8 to 20 W/cm². During operation, the reactor temperatures are typically in the range of 600 to 900° C., with the hottest parts of the reactor approaching and perhaps exceeding 900° C. At these high temperatures, creep rupture is the failure mechanism of concern. COMSOL simulations of the two-layer reactor design, assuming steam-methane reforming, were conducted using a constant heating rate of 6 kW. First the temperature profile for the reactor was solved, then this temperature profile was used to calculate the thermal expansion stress, along with the stress resulting from the operating pressure. Initial calculations showed stresses as high as 330 MPa (50 ksi) on the reactor surface and similar stresses internally at some of the hottest parts of the reactor.

To reduce the stress in the hottest portions of the reaction side walls, several design alternatives were simulated. One of these was to increase the thickness of the reaction channel side wall near the perimeter of the reactor. This decreases the tension (pulling the top and bottom plates apart) stress due to pressure; however, an unexpected benefit is that strengthening this part of the reaction channel wall changes how the thermal expansion stress in the reactor is manifested. The increased stiffness of the side wall near the hot perimeter of the reactor causes the maximum thermal expansion stress in the wall to move toward the center of the reactor. This is beneficial since the reactor in operation is cooler towards the center, and the metal alloies have better strength and creep rupture properties at lower temperatures.

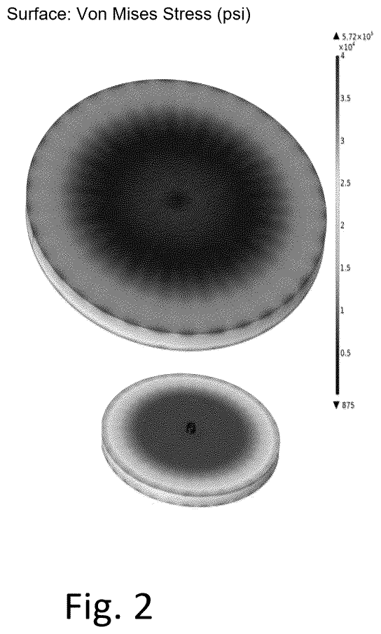

With the strengthened reaction channel walls, simulation showed reduced thermal expansion stresses in the range of 130 to 200 MPa (20 to 30 ksi). The highest stress was on the surface of the reactor and was located on the cooler non heated top surface. The hot surface of the reactor showed a maximum stress of around 22 ksi, ⅓ lower compared to the base case 2-layer reactor design. FIG. 2 shows the stress on the outside surface of the reactor; stress was also calculated in reactor cross sections (not shown).

The simulations performed on the two-layer reactor design used a constant heat flux over the surface of the reactor. The higher temperature gradients caused by higher fluxes is a major contributor to the temperature gradients in the reactors structure that result in higher than desired thermal expansion stress. Higher heat fluxes also result in higher maximum temperatures. Changing the heat flux profile to one where the heat flux is higher near the center of the reactor and decreases toward the perimeter of the reactor is beneficial since more heat is put into the reactor where it is coolest and material strength is highest. Lower heat input toward the hot perimeter reduces the maximum temperature and temperature gradients in the hottest portions of the reactor. With induction heating, this can be accomplished by adjusting the magnetic field through design of the induction coil to cause more induction heating toward the center of the reactor. This reduces the thermal expansion stress in these hottest parts of the reactor.

### Three-Layer Reactor

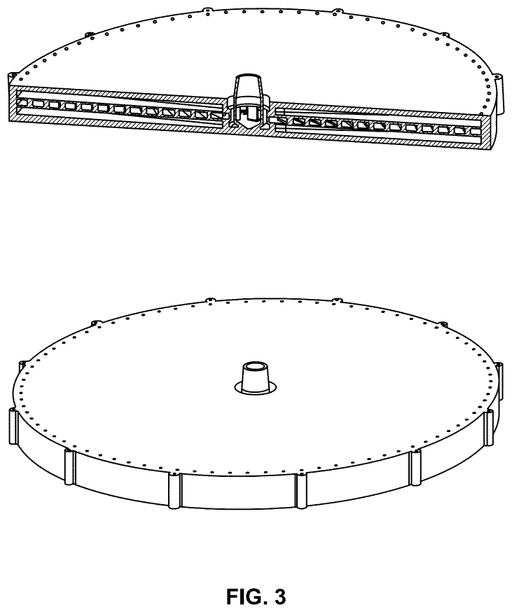

A useful method for reducing thermal expansion stress is to reduce the heat flux per area of reactor surface. However, it is also desirable to maximize the throughput of a reactor of given size. To accomplish this a three-layer reactor design has been developed. The concept is a disk-shaped reactor that is heated on both sides. FIG. 3 shows drawings of a three-layer reactor.

In the three-layer reactor methane and steam flow into a header that distributes flow to catalyst filled channels contained next to the top and bottom surfaces of the reactor. As with the channels in the two-layer reactor, these catalyst channels may be less than 1 mm thick or up to 1 cm thick or more, but are preferably are 3 to 6 mm thick in the direction parallel to the heat input. Heat is applied to both the top and bottom surfaces of the reactor to supply heat to the endothermic reaction. The heat can be applied using electrical inductive heating, electrical resistive heating or other heat sources as described in the previous discussion of the two-layer reactor. A special case is using a solar concentrator to provide heat to one side and another method of heating to the other side.

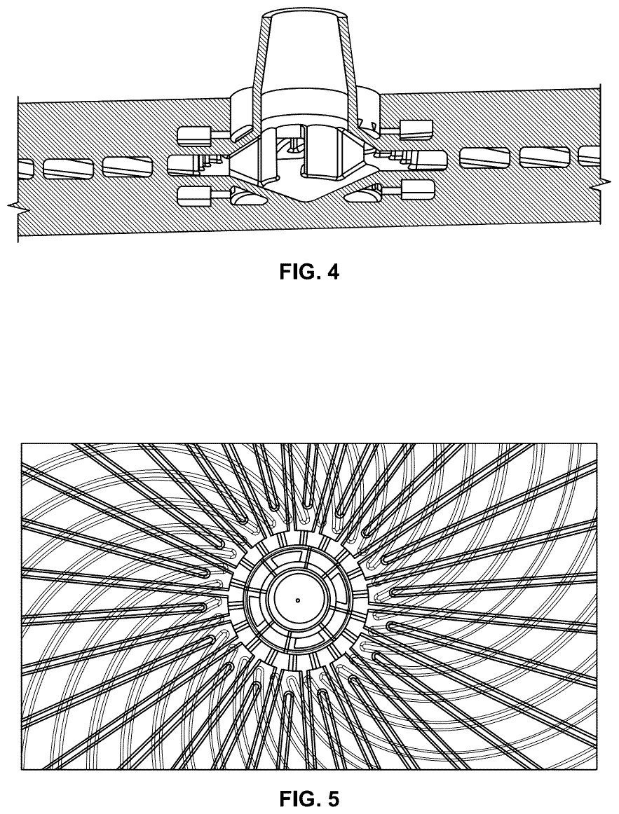

The reactor is designed for a total heat input of 8 to 12 kW but reactors can be designed for lessor or greater heat fluxes, ranging from less than 1 kW to tens of kWs (e.g., 50 or 70 KW), or over 100 KW. FIG. 4 shows a close view of the header that distributes flow to the catalyst filled reaction channels and collects flow from the recuperation channels. The inlets to the reaction channels include flow restricted channels (triangular in cross section) that are designed to provide pressure drop to evenly distribute flow to the multiple reaction channels.

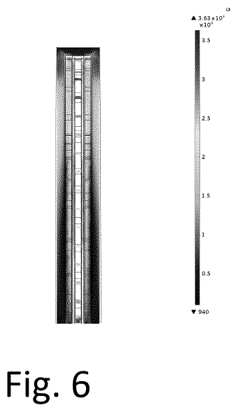

The embodiments illustrated in the figures are not intended to limit the invention. For example, although FIG. 4 illustrates a cylindrically symmetrical manifold; in alternative embodiments, inlets and outlets can be off-center. The disk-shaped reactor can have a hole through the center and could, for example, be enclosed in a toroidal solenoid for inductively heating a reactor. Also, as in the two-layer reactor, the reaction and recuperation channels can be straight, curved (e.g., spiral) or combinations. One configuration with straight reaction channels and curved recuperation channels, providing counter-cross flow heat transfer (FIG. 5, is designed to help distribute heat between hot and cold reaction channels caused by potentially uneven heat input.

Since the three-layer reactor is heated on both the top and bottom surfaces, both the hot top and bottom surfaces expand at roughly the same amount. Due to this, the reactor does not assume a dish or bowl shape but remains relatively flat. However, since the reactor does not dish, increased thermal expansion stresses can be present due to the hot exterior surfaces of the reactor, and the cooler interior temperatures. In finite element simulations of the three-layer reactor high stresses have been seen in the side walls of the reactor due to thermal expansion stresses. FIG. 10 shows the temperature profile of a three-layer reactor that has a uniform heat flux on the top and bottom heated surfaces. The simulation assumes a constant heat input on the top and bottom surfaces over the catalyst containing portion of the reactor. In the simulation the methane and steam inlet flow was maintained at a 3 to 1 steam to methane ratio and the inlet flow adjusted to achieve the desired conversion. In the three-layer reactor, high thermal expansion stresses were seen in the reaction channel side walls near the perimeter of the device stress in the reaction channel wall is above 344 MPa (50 ksi) caused by thermal expansion on the outside heated surfaces stretching the reaction channel side walls.

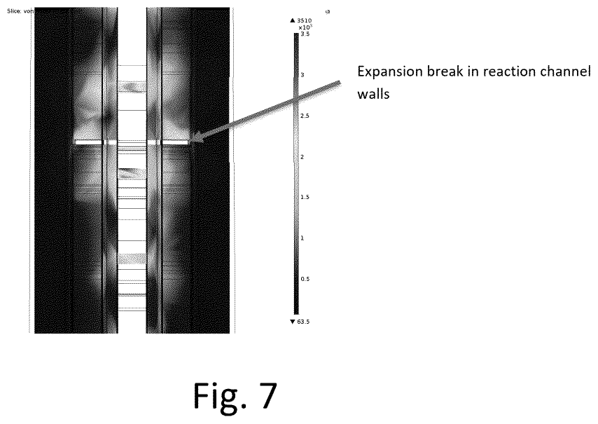

Two methods were devised for decreasing the thermal expansion stresses in the internal portions of the reactor. The first was to increase the thickness of the reaction channel side walls toward the perimeter of the device. Such as was the case with the two layer reactor, this decreased the overall stress in the side walls, and moved the maximum stress in the side walls toward the center of the reactor, where the reactor is cooler and the high temperature alloy is better able to withstand stress without rupture or deformation. FIG. 6 shows simulation results for a three-layer reactor with reaction channel side walls with increased thickness toward the perimeter.

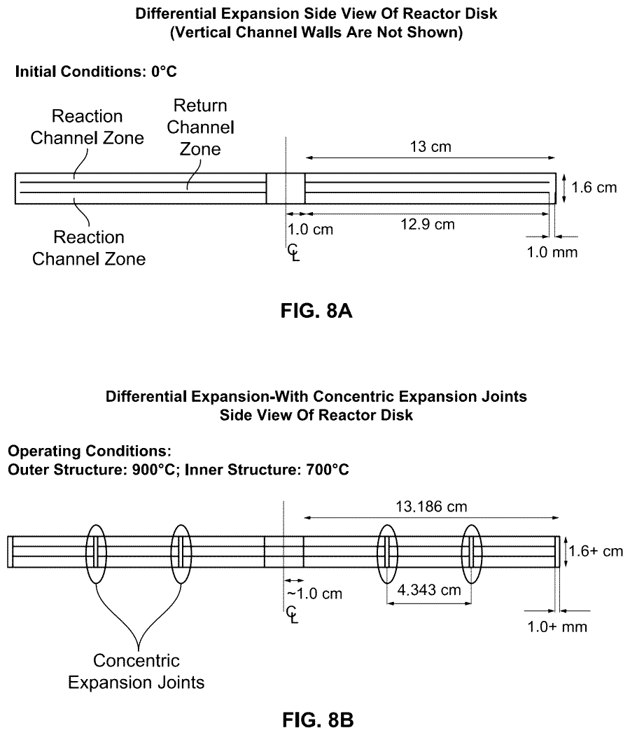

The second method of reducing the stress was to incorporate one or more breaks in the reaction channel walls. The break acts in a similar manner to an expansion joint in a sidewalk or concrete floor and allows the outside of the reactor to expand without the cumulative stretching of the internal parts of the reactor. This expansion joint concept eliminates almost all the thermal expansion stress. However, the challenge in utilizing an expansion break it is that a break in the reaction channel wall provides a potential path for flow through the joint from the higher-pressure reaction channel to the lower pressure recuperation channel. Substantial flow bypass (FIG. 7) would be detrimental to the performance of the reactor and could result in overheating or poor conversion.

### Thermal Expansion Joints

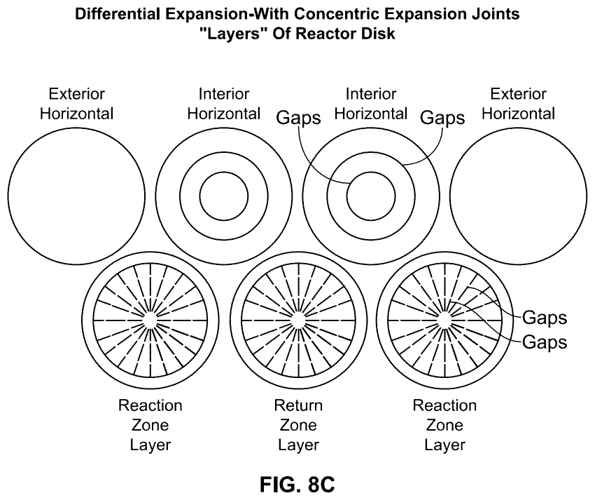

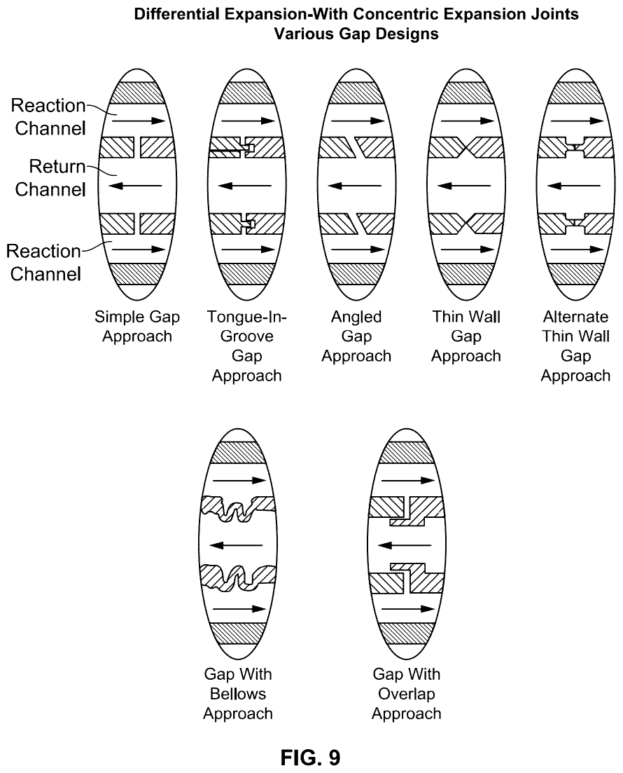

Simulations show a thermal expansion break can greatly reduce thermal expansion stress in the three-layer design. This type of break would also reduce stress in 2-layer reactors. Several concepts for providing a thermal break while preventing flow bypass are shown in FIGS. 8-9. These figures show the amount of strain (difference in length) that could be seen in a reactor that is hot on the outside and cooler in the center.

Another way to achieve a thermal break is to make catalyst inserts with impervious walls that would prevent flow from the catalyst channel through the structural wall between the reaction and recuperation channels. This would provide a sliding joint that would prevent the undesired flow bypass. Another concept is to provide a bellows structure in the side wall that would allow some flexing and movement of the side wall channels without creating large stresses. It is anticipated that the bellows portion could protrude into the recuperation channel to allow easy filling of the catalyst channel. Thus, in a preferred construction, the bellows is designed to project into the heat exchange channel and not protrude into the reaction channel so that a catalyst can be easily inserted into the reaction channel.

### Other Reactor Concepts

The two-and three-layer reactor concepts previously described can be heated respectively on one (two-layer) and both (three-layer) sides. Another concept that has been investigated is a two-layer reactor that is heated on both sides. In this concept the flow channels are arranged in a similar manner as in the two-layer reactor, however, catalyst is also placed into the return channels. This catalyst in the return channels may or may not run all the way to the headers. For example, catalyst may be placed in the outer ½ or ⅓ or the reactor. Heat is applied on the surfaces next to the position of catalyst placement. Using this concept, the heat flux can be reduced, and the hottest portion of the reactor moves away from the rim of the reactor. This provides an advantage in reducing maximum reactor temperature for a given heat input and hydrogen production rate.

### Simulations

Computer simulations were conducted for two-and three-layer versions of endothermic reactors. The simulations were for methane reforming reactions incorporating a rhodium-based catalyst operating in the range of 700 to 900° C. to convert methane and water to synthesis gas. The reaction is endothermic requiring the input of heat. With the circular flat plate (disk shaped) reactors described here, heat is applied to one or more of the flat surfaces. The methane and steam enter at the center of the flat plate and flow outward through catalyst filled channels toward the perimeter of the disk. At the perimeter the reacted flow that consists of hydrogen, carbon monoxide, carbon dioxide with unreacted methane and water is returned toward the center of the reactor in recuperation channels. The reaction requires high temperatures, and heat can be applied to the reactor surface adjacent to the catalyst through several means including solar heating, inductive heating, electrical resistive heating, microwave heating or other means. The reactor simulations were performed using COMSOL™ Multiphysics. A flow-reaction simulation was performed first. This simulation provided a temperature profile for the reactor based on the desired operating conditions including inlet flow rate, inlet temperature, heat input, and conversion. In using the model, the heat input was provided along with the pressure and the flowrate was adjusted to reach the desired conversion.

After the temperature profile of the reactor was simulated, this temperature profile was used to model the thermal stress, and other stresses in the part. This was done using the structural mechanics module in COMSOL Multiphysics. The stress-strain calculations used average properties for Haynes 282 at the average operating temperature. The displacement of the reactor was constrained at the inlet header at three points, and a pressure boundary condition was applied to the internal surfaces of the reactor. To test the contribution of stress due to thermal expansion, the thermal expansion part of the calculation could be turned off.

The invention includes any of the reactors, any of the components, and any combination of the components that are described herein. The invention also includes any of the methods, method steps, and any combination of the method steps described herein. The methods are typically described in combination with a component or any combination of components. The invention also includes systems comprising both a reactor or component or any combination of components in conjunction with fluids and/or catalysts and/or conditions which are described herein. Methods of the invention include methane steam reforming, reforming (including dry reforming) of methane or other hydrocarbons, reverse-water-gas shift and other endothermic reactions. The reactor could include additional layers, that may incorporate exothermic reactions as well, such as partial oxidation.

1. A disk-shaped apparatus, comprising:
a central axis;
a disk comprising a first set of channels radiating from the central axis toward the perimeter of the disk;
wherein the first set of channels comprise a plurality of channels wherein each of the channels in the plurality of channels comprise at least one inlet disposed around the central axis;
a fluid inlet disposed parallel to and along the central axis;
a plurality of connections between the fluid inlet and the at least one inlet of each of the channels;
wherein each channel has a first cross-sectional area that is perpendicular to channel length and each single inlet or plurality of inlets has a second cross-sectional area;
wherein the disk comprises a circular top wall over a major surface of the disk and a cylindrical side wall around the perimeter of the disk;
and further comprising one or any combination of the following features:
wherein each channel in the plurality of channels comprises an expansion joint along the channel length;
wherein the side wall is thicker or stiffer than the top wall;
wherein each of the channels in the plurality of channels have a width that is perpendicular to length and thickness and wherein the width narrows toward the perimeter of the disk so that the wall thickness increases toward the perimeter; or
wherein the second cross-sectional area is at least 20%, or 50%, or 70% less than the first cross-sectional area.

2. The apparatus of claim 1 wherein each wall of the reactor is made of a single material; and wherein the single material is a superalloy.

3. The apparatus of claim 1 wherein each channel in the plurality of channels comprises an expansion joint along the channel length.

4. The apparatus of claim 3 wherein the expansion joint is selected from the group consisting of: a tongue-in-groove joint, an angled gap, a thinned wall, a thinned wall to a gap, bellows, or a gap with an overlapping flange.

5. The apparatus of claim 4 wherein the expansion joint comprises an angled gap wherein the angled gap is angled in the direction of flow, angled against flow, or angled with a V.

6. The apparatus of claim 4 wherein the expansion joint is a tongue-in-groove joint.

7. The apparatus of claim 4 wherein the expansion joint comprises a thinned wall wherein the wall thins to a thickness that is at least 40% thinner (or at least 60% thinner) than the average thickness of the wall; wherein the average is over the length of the channel not including the thinned section.

8. The apparatus of claim 1 wherein the side wall is thicker or stiffer than the top wall.

9. The apparatus of claim 1 wherein the side wall is made of a material that is stiffer than the top wall.

10. The apparatus of claim 3 wherein each of the channels in the plurality of channels have a width that is perpendicular to length and thickness and wherein the width narrows toward the perimeter of the disk so that the wall thickness increases toward the perimeter.

11. The apparatus of claim 1 wherein the central fluid inlet is perpendicular to each of the channels in the plurality of channels.

12. The apparatus of claim 1 wherein the reactor comprises a first disk-shaped layer of reaction channels comprising a solid catalyst and a second disk-shaped layer comprising heat recuperation channels wherein reaction products made in the first layer can pass into return channels in the second layer that return toward the central axis.

13. The apparatus of claim 1 wherein the second cross-sectional area is at least 20%, or 50%, or 70% less than the first cross-sectional area.

14. The apparatus of claim 3 wherein the expansion joint comprises a bellows.

15. The apparatus of claim 1 wherein the disk-shaped apparatus has a thickness parallel to the central axis, and comprising a central aperture through the entire thickness of the disk-shaped apparatus.

16. A method of conducting a thermal chemical reaction, comprising passing a reactant into the apparatus of claim 12, and further comprising a step of adding heat into the reaction channels through an exterior wall of the reaction channels that is opposite the heat recuperation channels.

17. A method of conducting a thermal chemical reaction, comprising:
providing a disk shaped apparatus, comprising:
a central axis;
a disk comprising a first set of channels radiating from the central axis toward the perimeter of the disk;
wherein the first set of channels comprise a plurality of channels wherein each of the channels in the plurality of channels comprise at least one inlet disposed around the central axis;
a fluid inlet disposed parallel to and along the central axis;
a plurality of connections between the fluid inlet and the at least one inlet of each of the channels;
wherein the disk comprises a circular top wall over a major surface of the disk and a cylindrical side wall around the perimeter of the disk;
applying heat through the major surface of the disk (e.g., the Exterior Horizontal plate of FIG. 8c)
wherein the heat flux is higher near the center of the reactor and decreases toward the perimeter of the reactor.

18. The method of claim 17 wherein heat flux over the 50% of area of the major surface nearest the center of the disk is at least 10% greater or at least 20% greater than the 50% of area of the major surface furthest from the center of the disk.

19. A disk shaped apparatus, comprising:
a central axis;
a disk comprising a first set of channels radiating from the central axis toward the perimeter of the disk;
wherein the first set of channels comprise a plurality of channels wherein each of the channels in the plurality of channels comprise at least one inlet disposed around the central axis;
a fluid inlet disposed parallel to and along the central axis;
a plurality of connections between the fluid inlet and the at least one inlet of each of the channels;
wherein the disk comprises a circular top wall over a major surface of the disk and a cylindrical side wall around the perimeter of the disk;
wherein the first set of channels define a first layer;
and further comprising a second layer adjacent to the first layer;
wherein the second layer comprises a second set of channels extending from the perimeter of the disk to the central axis, and wherein the first set of channels connect to the second set of channels at the perimeter so that flow from the first set of channels passes into the second set of channels; and
wherein a catalyst is present in the first set of channels and wherein the catalyst is present in the second set of channels such that at least 90 mass % of the catalyst in the second set of channels is present in the 50% of channel length closest to the perimeter.

20. A method of conducting a thermal chemical reaction, comprising:
conducting a thermal chemical reaction in the apparatus of claim 19.
